(19) United States
(12) Patent Application Publication
(10) Pub. No.: US 2025/0093618 A1
(43) Pub. Date: Mar. 20, 2025

(54) CAMERA OPTICAL LENS

(71) Applicant: AAC Optics (Suzhou) Co., Ltd., Suzhou (CN)

(72) Inventors: Tingting Yang, Suzhou (CN); Shunda Zhou, Suzhou (CN)

(21) Appl. No.: 18/399,773

(22) Filed: Dec. 29, 2023

(30) Foreign Application Priority Data
Sep. 19, 2023 (CN) 202311210779.5

(51) Int. Cl. G02B 13/00; G02B 9/12

(52) U.S. Cl. CPC G02B 13/0035; G02B 9/12

(57) ABSTRACT

A camera optical lens includes: first lens, second lens and third lens. Focal length f of camera optical lens, focal length f1 of first lens, on-axis distance d2 from image-side surface of the first lens to object-side surface of the second lens, total optical length TTL, field of view FOV of camera optical lens, full field image height IH of camera optical lens, curvature radius R5 of object-side surface of third lens, curvature radius R6 of image-side surface of third lens, refractive index n1 of first lens satisfy following relational expressions: 0.80≤f1/f≤1.60; 0.14≤d2/TTL≤0.22; 100.00≤(FOV*f)/IH≤115.00; 1.40≤R5/R6≤4.00; and 1.70≤n1≤2.10. The camera optical lens has low sensitivity and capability of achieving medium- to long-range distance imaging while having good optical performance.

### TECHNICAL FIELD

The present disclosure relates to the field of optical lens technologies, and in particular, to a camera optical lens applicable to handheld terminal devices such as smart phones, digital cameras, and camera devices such as monitors and PC lenses, vehicle-mounted lenses.

### BACKGROUND

In recent years, with the rapid development of the automobile industry, the requirements for identification of drivers, detection of fatigue driving and dangerous behaviors of drivers, are increasingly improved through a driver monitoring system, and the driver monitoring system is mainly implemented through a vehicle-mounted camera optical lens, so that a camera optical lens with good imaging quality and low sensitivity becomes a mainstream in the current market for improving detection precision.

In order to obtain better imaging quality, and with the development of technology and the increase of diversified requirements of users, under the condition that the pixel area of the optical sensor is continuously reduced and the requirements on the imaging quality of the system are continuously improved, the three-piece lens structure gradually appears in the lens design, although the common three-piece lens already has better optical performance, the refractive power, the lens spacing and the lens shape setting still have certain irrationality, so that the lens structure has good optical performance in the application of the driver monitoring system, but cannot meet the design requirements of lower sensitivity and longer distance imaging at the same time.

### SUMMARY

In view of the above problems, an object of the present disclosure is to provide a camera optical lens, which has low sensitivity and can achieve medium- to long-range distance imaging while having good optical performance.

In order to solve the above technical problem, the present disclosure provides a camera optical lens, which sequentially includes: a first lens, a second lens and a third lens;

wherein a focal length of the camera optical lens is f, a focal length of the first lens is f1, an on-axis distance from an image-side surface of the first lens to an object-side surface of the second lens is d2, a total optical length from an object side surface of the first lens to an image plane of the camera optical lens along an optic axis of the camera optical lens is TTL, a field of view of the camera optical lens is FOV, a full field image height of the camera optical lens is IH, a curvature radius of an object-side surface of the third lens is R5, a curvature radius of an image-side surface of the third lens is R6, a refractive index of the first lens is n1, and following relational expressions are satisfied:

$$0.8 \leq f 1 / f \leq 1.6 ; \\ 0.14 \leq d 2 / TTL \leq 0.22 ; \\ 100. \leq ( FOV * f ) / H \leq 115. ; \\ 1.4 \leq R 5 / R 6 \leq 4. ; and \\ 1. 70 \leq n 1 \leq 2.10 .$$

As an improvement, a focal length of the second lens is f2, an on-axis thickness of the second lens is d3, and a following relational expression is satisfied:

$$1.5 \leq f 2 / d 3 \leq 4. .$$

As an improvement, a curvature radius of the object-side surface of the second lens is R3, a curvature radius of the image-side surface of the second lens L2 is R4, and a following relational expression is satisfied:

$$1. 50 \leq R 3 / R 4 \leq 5. .$$

As an improvement, the focal length of the third lens is f3, and a following relational expression is satisfied:

$$- 1.2 \leq f 3 / f \leq - 0.6 .$$

As an improvement, the first lens has a positive refractive power, an object-side surface of the first lens is convex in a paraxial region, and an image-side surface of the first lens is concave in the paraxial region;

a curvature radius of an object-side surface of the first lens is R1, a curvature radius of an image-side surface of the first lens is R2, and an on-axis thickness of the first lens is d1, and following relational expressions are satisfied:

$$- 126.25 \leq ( R 1 + R 2 ) / ( R 1 - R 2 ) \leq - 1.8 ; and$$

$$0.08 \leq d 1 / TTL \leq 0.45 .$$

As an improvement, the second lens has a positive refractive power, an object-side surface of the second lens is concave in a paraxial region, and an image-side surface of the second lens is convex in the paraxial region;

a focal length of the second lens is f2, an on-axis thickness of the second lens is d3, a curvature radius of an object-side surface of the second lens is R3, a curvature radius of an image-side surface of the second lens is R4, and following relational expressions are satisfied:

$$0.23 \leq f 2 / f \leq 1.61 ;$$

$$0.75 \leq ( R 3 + R 4 ) / ( R 3 - R 4 ) \leq 7.43 ; and$$

$$0.09 \leq d 3 / TTL \leq 0.36 .$$

As an improvement, the third lens has a negative refractive power, an object-side surface of the third lens is convex in a paraxial region, and an image-side surface of the third lens is concave in the paraxial region;

an on-axis thickness of the third lens is d5 and following relational expressions are satisfied:

$$0.83 \leq ( R 5 + R 6 ) / ( R 5 - R 6 ) \leq 8.91 ; and$$

$$0.02 \leq d 5 / TTL \leq 0.12 .$$

As an improvement, a combined focal length of the first lens and the second lens is f12, and a following relational expression is satisfied:

$$0.31 \leq f 12 / f \leq 1.18 .$$

As an improvement, an F-number of the camera optical lens is FNO, and a following relational expression is satisfied:

FNO≤3.47.

As an improvement, the first lens is made of glass material, and the second lens and the third lens are made of plastic.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a structural schematic diagram of a camera optical lens according to Example 1 of the present disclosure;

FIG. 2 is a schematic diagram of field curvature and distortion of the camera optical lens shown in FIG. 1;

FIG. 3 is a schematic diagram of lateral color of the camera optical lens shown in FIG. 1;

FIG. 4 is a schematic diagram of longitudinal aberration of the camera optical lens shown in FIG. 1;

FIG. 5 is a structural schematic diagram of a camera optical lens according to Example 2 of the present disclosure;

FIG. 6 is a schematic diagram of field curvature and distortion of the camera optical lens shown in FIG. 5;

FIG. 7 is a schematic diagram of lateral color of the camera optical lens shown in FIG. 5;

FIG. 8 is a schematic diagram of longitudinal aberration of the camera optical lens shown in FIG. 5;

FIG. 9 is a structural schematic diagram of a camera optical lens according to Example 3 of the present disclosure;

FIG. 10 is a schematic diagram of field curvature and distortion of the camera optical lens shown in FIG. 9;

FIG. 11 is a schematic diagram of lateral color of the camera optical lens shown in FIG. 9;

FIG. 12 is a schematic diagram of longitudinal aberration of the camera optical lens shown in FIG. 9;

FIG. 13 is a structural schematic diagram of a camera optical lens according to Example 4 of the present disclosure;

FIG. 14 is a schematic diagram of field curvature and distortion of the camera optical lens shown in FIG. 13;

FIG. 15 is a schematic diagram of lateral color of the camera optical lens shown in FIG. 13;

FIG. 16 is a schematic diagram of longitudinal aberration of the camera optical lens shown in FIG. 13;

FIG. 17 is a structural schematic diagram of a camera optical lens according to Example 5 of the present disclosure;

FIG. 18 is a schematic diagram of field curvature and distortion of the camera optical lens shown in FIG. 17;

FIG. 19 is a schematic diagram of lateral color of the camera optical lens shown in FIG. 17;

FIG. 20 is a schematic diagram of longitudinal aberration of the camera optical lens shown in FIG. 17;

FIG. 21 is a structural schematic diagram of a camera optical lens according to a Comparative Example of the present disclosure;

FIG. 22 is a schematic diagram of field curvature and distortion of the camera optical lens shown in FIG. 21;

FIG. 23 is a schematic diagram of lateral color of the camera optical lens shown in FIG. 21; and

FIG. 24 is a schematic diagram of longitudinal aberration of the camera optical lens shown in FIG. 21.

### DESCRIPTION OF EMBODIMENTS

In order to more clearly illustrate objectives, technical solutions, and advantages of embodiments of the present disclosure, the technical solutions in embodiments of the present disclosure are clearly and completely described in details with reference to the accompanying drawings. The described embodiments are merely part of the embodiments of the present disclosure rather than all of the embodiments. All other embodiments obtained by those skilled in the art based on the embodiments of the present disclosure without paying creative labor shall fall into the protection scope of the present disclosure.

### Example 1

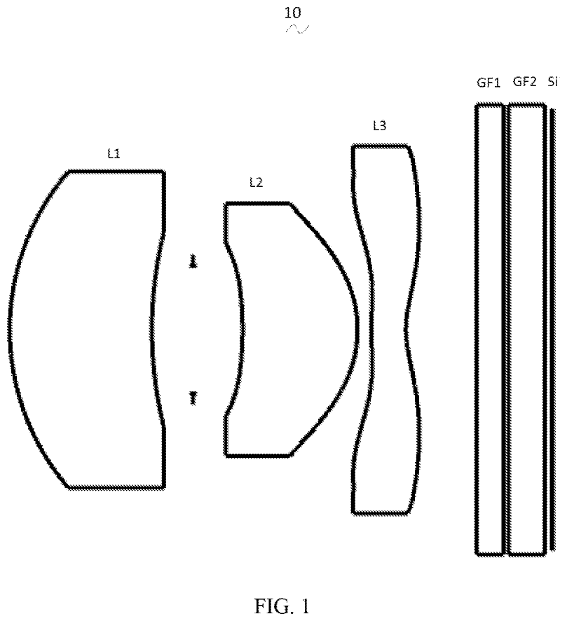

As shown in FIG. 1 to FIG. 4, Example 1 of the present disclosure provides a camera optical lens 10. The camera optical lens 10 includes three lenses. Specifically, the camera optical lens 10 includes from an object side to an image side: the first lens L1, the second lens L2, and the third lens L3. An optical element such as a optical filter GF may be disposed between the third lens L3 and the image surface Si. In this embodiment, two optical filters may be provided between the third lens L3 and the image surface Si, respectively a first optical filter GF1 and a second optical filter GF2.

In this embodiment, the first lens L1 is made of glass, the second lens L2 is made of plastic, and the third lens L3 is made of plastic. By reasonably configuring the material of the lens, the lens assembly has good optical performance. Among them, a refractive index of the first lens L1 is n1, and a following relational expression is satisfied: 1.70≤n1≤2.10, the first lens L1 is made of a high-refractive-index glass, which is beneficial to reducing a front-end aperture and improving imaging quality.

In this embodiment, a focal length of the camera optical lens 10 is defined as f, and a focal length of the first lens L1 is defined as f1, and a following relational expression is satisfied: 0.80≤f1/f≤1.60, which specifies a ratio of the focal length f1 of the first lens L1 to the focal length f of the camera optical lens 10, and within the specified range of the relational expression, the camera optical lens 10 has better imaging quality and lower sensitivity by reasonably distributing the focal length of the camera optical lens 10.

In this embodiment, an on-axis distance from an image-side surface of the first lens L1 to an object-side surface of the second lens L2 is defined as d2, and the total optical length from the object side surface of the first lens to an image plane of the camera optical lens along an optic axis of the camera optical lens 10 is defined as TTL, and a following relational expression is satisfied: 0.14≤d2/TTL≤0.22, which specifies a ratio of an air gap between the first lens L1 and the second lens L2 to a total optical length from the object side surface of the first lens to an image plane of the camera optical lens along an optic axis of the camera optical lens 10, and within the range of the relational expression, it is helpful to compress the total length of the optical system and achieve an ultra-thin effect.

In this embodiment, a field of view of the camera optical lens 10 is defined as FOV, a full field image height of the camera optical lens 10 is defined as IH, and a following relational expression is satisfied: 100.00≤(FOV*f)/IH≤115.00, and within a range of the relational expression, the field of view FOV and the focal length f of the camera optical lens 10 are both considered, to achieve medium- to long-range distance imaging.

In this embodiment, a curvature radius of an object-side surface of the third lens L3 is defined as R5, and a curvature radius of an image-side surface of the third lens L3 is defined as R6, and a following relational expression is satisfied: 1.40≤R5/R6≤4.00, which specifies a shape of the third lens L3, and within the range of the relational expression, it is beneficial to correct the astigmatism and distortion of the camera optical lens 10, so that the |Distortion|≤5%, thereby reducing the possibility of generation of dark angle.

In this embodiment, a focal length of the second lens L2 is defined as f2, and an on-axis thickness of the second lens L2 is defined as d3, and a following relational expression is satisfied: 1.50≤f2/d3≤4.00, within the range of the relational expression, it is helpful to mitigate the change of the incident angle of the large-view-angle light, so that the large-view-angle light smoothly transmits in the optical imaging lens assembly, while maintaining the refractive power intensity of the second lens L2, so as to improve the chromatic aberration and improve the imaging quality, and let the chromatic aberration |LC|≤1.0 μm.

In this embodiment, a curvature radius of an object-side surface of the second lens L2 is defined as R3, and a curvature radius of an image-side surface of the second lens L2 is defined as R4, and a following relational expression is satisfied: 1.50≤R3/R4≤5.00, which specifies a shape of the second lens L2, and within the range of the relational expression, it is beneficial to mitigate the degree of deflection of light passing through the lens, so that the camera optical lens 10 has better imaging quality and lower sensitivity.

In this embodiment, a focal length of the third lens L3 is defined as f3, a following relational expression is satisfied: −1.20≤f3/f≤−0.60, which specifies a ratio of the focal length f3 of the third lens L3 to the focal length f of the camera optical lens 10, and within the range of the relational expression, the camera optical lens 10 has better imaging quality and lower sensitivity by reasonably distributing the focal length of the camera optical lens 10.

In this embodiment, the first lens L1 has a positive refractive power. An object-side surface of the first lens L1 is convex in a paraxial region, and an image-side surface of the first lens L1 is concave in the paraxial region. In other optional embodiments, an object-side surface and the image-side surface of the first lens L1 may also be provided with other concave and convex distributions, and the first lens L1 may also have a negative refractive power.

In this embodiment, a curvature radius of an object-side surface of the first lens L1 is defined as R1, and a curvature radius of an image-side surface of the first lens L1 is defined as R2, a following relational expression is satisfied: −126.25≤(R1+R2)/(R1−R2)≤−1.80, which specifies a shape of the first lens L1, and within the range of the relational expression, it is beneficial to mitigate the degree of deflection of light passing through the lens, effectively reduce the aberration, and the camera optical lens 10 has better imaging quality and lower sensitivity. Optionally a following relational expression is satisfied: −78.91≤(R1+R2)/(R1−R2)≤−2.25.

In this embodiment, an on-axis thickness of the first lens L1 is defined as d1, and a following relational expression is satisfied: 0.08≤d1/TTL≤0.45, within the range of the relational expression, it is helpful to compress the total length of the optical system and achieve an ultra-thin effect. Optionally a following relational expression is satisfied: 0.13≤d1/TTL≤0.36.

In this embodiment, the second lens L2 has a positive refractive power. An object-side surface of the second lens L2 is concave in a paraxial region, and an image-side surface of the second lens L2 is convex in the paraxial region. In other optional embodiments, the object-side surface and the image-side surface of the second lens L2 may also be provided with other concave and convex distributions, and the second lens L2 may also have a negative refractive power.

In this embodiment, a focal length of the second lens L2 is defined as f2, and a following relational expression is satisfied: 0.23≤f2/f≤1.61, which specifies a ratio of the focal length f2 of the second lens L2 to the focal length f of the camera optical lens 10, and within the range of the relational expression, the camera optical lens 10 has better imaging quality and lower sensitivity by reasonably distributing the focal length of the camera optical lens 10. Optionally a following relational expression is satisfied: 0.36≤f2/f≤1.29.

In this embodiment, a curvature radius of an object-side surface of the second lens L2 is defined as R3, and a curvature radius of an image-side surface of the second lens L2 is defined as R4, and a following relational expression is satisfied: 0.75≤(R3+R4)/(R3−R4)≤7.43, which specifies a shape of the second lens L2, and within the range of the relational expression, it is beneficial to mitigate the degree of deflection of light passing through the lens, effectively reduce the aberration, so that the camera optical lens 10 has better imaging quality and lower sensitivity. Optionally a following relational expression is satisfied: 1.20≤(R3+R4)/(R3−R4)≤5.94.

In this embodiment, an on-axis thickness of the second lens L2 is defined as d3, and a following relational expression is satisfied: 0.09≤d3/TTL≤0.36, within the range of the relational expression, it is helpful to compress the total length of the optical system and achieve an ultra-thin effect. Optionally a following relational expression is satisfied: 0.14≤d3/TTL≤0.29.

In this embodiment, the third lens L3 has a negative refractive power. An object-side surface of the third lens L3 is convex in a paraxial region, and an image-side surface of the third lens L3 is concave in the paraxial region. In other optional embodiments, the object-side surface and the image-side surface of the third lens L3 may also be provided with other concave and convex distributions, and the third lens L3 may also have a positive refractive power.

In this embodiment, a curvature radius of an object-side surface of the third lens L3 is defined as R5, and a curvature radius of an image-side surface of the third lens L3 is defined as R6, and a following relational expression is satisfied: 0.83≤(R5+R6)/(R5−R6)≤8.91, which specifies a shape of the third lens L3, and within the range of the relational expression, it is beneficial to mitigate the degree of deflection of light passing through the lens, effectively reduce the aberration, so that the camera optical lens 10 has better imaging quality and lower sensitivity. Optionally a following relational expression is satisfied: 1.33≤(R5+R6)/(R5−R6)≤7.13.

In this embodiment, an on-axis thickness of the third lens L3 is defined as d5, and a following relational expression is satisfied: 0.02≤d5/TTL≤0.12, within the range of the relational expression, it is helpful to compress the total length of the optical system and achieve an ultra-thin effect. Optionally a following relational expression is satisfied: 0.02≤d5/TTL≤0.10.

In this embodiment, a combined focal length of the first lens L1 and the second lens L2 is defined as f12, and a following relational expression is satisfied: 0.31≤f12/f≤1.18, within the range of the relational expression, aberration and distortion of the camera optical lens 10 may be eliminated, and the back focal length of the camera optical lens 10 may be suppressed, to maintain the miniaturization of the image lens system assembly. Optionally a following relational expression is satisfied: 0.50≤f12/f≤0.95.

In this embodiment, an F-number of the camera optical lens 10 is defined as FNO, and a following relational expression is satisfied: FNO≤3.47, large aperture, and good imaging performance. Optionally a following relational expression is satisfied: FNO≤3.41.

When the above relational expression is satisfied, the camera optical lens 10 has low sensitivity, and can achieve medium- to long-range distance imaging while having good optical performance. According to the characteristics of the camera optical lens 10, the camera optical lens 10 is particularly suitable for a vehicle-mounted camera optical lens 10 of a driver monitoring system, and the working wave band is a near-infrared wave band.

The camera optical lens 10 of the present disclosure will be described below with examples. The symbols recited in each example are as follows: The units of the focal length, the on-axis distance, curvature radius, the on-axis thickness, the position of the inflection point, and the position of the stationary point are mm.

TTL: total optical length from the object side surface of the first lens to an image plane of the camera optical lens along an optic axis (the on-axis distance from the object-side surface of the first lens L1 to the image surface Si), in mm.

In addition, at least one of the object-side surface and the image-side surface of each lens may be further provided with an inflection point and/or a stationary point, so as to meet high-quality imaging requirements.

Table 1 and Table 2 show design data of the camera optical lens 10 shown in FIG. 1.

TABLE 1

| | R | d | | nd | | νd | |
|---|---|---|---|---|---|---|---|
| S1 | ∞ | d0= | −2.006 | | | | |
| R1 | 2.658 | d1= | 1.556 | nd1 | 1.9108 | ν1 | 35.25 |
| R2 | 4.477 | d2= | 0.990 | | | | |
| R3 | −4.277 | d3= | 1.258 | nd2 | 1.6613 | ν2 | 20.37 |
| R4 | −1.542 | d4= | 0.149 | | | | |
| R5 | 2.097 | d5= | 0.380 | nd3 | 1.6613 | ν3 | 20.37 |
| R6 | 1.041 | d6= | 0.771 | | | | |
| R7 | ∞ | d7= | 0.300 | ndg1 | 1.5168 | νg1 | 64.17 |
| R8 | ∞ | d8= | 0.050 | | | | |
| R9 | ∞ | d9= | 0.400 | ndg2 | 1.5168 | νg2 | 64.17 |
| R10 | ∞ | d10= | 0.076 | | | | |

The meaning of each symbol in the above table is as follows:
S1: aperture;
R: central curvature radius at the center of the optical surface;
R1: curvature radius of the object-side surface of the first lens L1;
R2: curvature radius of the image-side surface of the first lens L1;
R3: curvature radius of the object-side surface of the second lens L2;
R4: curvature radius of the image-side surface of the second lens L2;
R5: curvature radius of the object-side surface of the third lens L3;
R6: curvature radius of the image-side surface of the third lens L3;
R7: curvature radius of the object-side surface of the optical filter GF1;
R8: curvature radius of the image-side surface of the optical filter GF1;
R9: curvature radius of the object-side surface of the optical filter GF2;
R10: curvature radius of the image-side surface of the optical filter GF2;
d: on-axis thickness of lenses, on-axis distance between lenses;
d0: on-axis distance from the aperture S1 to the object-side surface of the first lens L1;
d1: an on-axis thickness of the first lens L1;
d2: on-axis distance from the image-side surface of the first lens L1 to the object-side surface of the second lens L2;
d3: on-axis thickness of the second lens L2;
d4: on-axis distance from the image-side surface of the second lens L2 to the object-side surface of the third lens L3;
d5: on-axis thickness of the third lens L3;
d6: on-axis distance from the image-side surface of the third lens L3 to the object-side surface of the optical filter GF1;
d7: on-axis thickness of the optical filter GF1;
d8: on-axis distance from the image-side surface of the optical filter GF1 to the object-side surface of the optical filter GF2;
d9: on-axis thickness of the optical filter GF2;
d10: on-axis distance from the image side surface of the optical filter GF2 to the image surface S1;
nd: refractive index of d line;
nd1: refractive index of d line of the first lens L1;
nd2: refractive index of d line of the second lens L2;
nd3: refractive index of d line of the third lens L3;
ndg1: refractive index of d line of optical filter GF1;
ndg2: refractive index of d line of optical filter GF2;
vd: abbe number;
v1: abbe number of the first lens L1;
v2: abbe number of the second lens L2;
v3: abbe number of the third lens L3;
vg1: abbe number of optical filter GF1;
vg2: abbe number of the optical filter GF2.

Table 2 shows aspheric surface data of each lens in the camera optical lens 10 according to Example 1 of the present disclosure.

TABLE 2

| | |
|---|---|
| Conic Coefficient | Aspherical Coefficient |

| | k | A4 | A6 | A8 | A10 | A12 |
|---|---|---|---|---|---|---|
| R3 | 1.2911E+01 | −8.1428E−02 | 8.1118E−01 | −1.2707E+01 | 1.1483E+02 | −6.7922E+02 |
| R4 | −2.5535E+00 | −6.7915E−01 | 2.8457E+00 | −8.6618E+00 | 1.7870E+01 | −2.2736E+01 |
| R5 | −2.4036E+01 | −1.0882E+00 | 3.1912E+00 | −7.0179E+00 | 1.1440E+01 | −1.3683E+01 |
| R6 | −8.2016E+00 | −3.5262E−01 | 6.8241E−01 | −1.0588E+00 | 1.2679E+00 | −1.1838E+00 |

| | Conic Coefficient | Aspherical Coefficient | | | | |
|---|---|---|---|---|---|---|
| | k | A14 | A16 | A18 | A20 | A22 |
| R3 | 1.2911E+01 | 2.7717E+03 | −8.0466E+03 | 1.6890E+04 | −2.5713E+04 | 2.8108E+04 |
| R4 | −2.5535E+00 | 1.0334E+01 | 2.0897E+01 | −5.0794E+01 | 5.6729E+01 | −3.9476E+01 |
| R5 | −2.4036E+01 | 1.2049E+01 | −7.8215E+00 | 3.7271E+00 | −1.2867E+00 | 3.1343E−01 |
| R6 | −8.2016E+00 | 8.7583E−01 | −5.1442E−01 | 2.3615E−01 | −8.2458E−02 | 2.1167E−02 |

| | |
|---|---|
| Conic Coefficient | Aspherical Coefficient |

| | k | A24 | A26 | A28 | A30 |
|---|---|---|---|---|---|
| R3 | 1.2911E+01 | −2.1481E+04 | 1.0883E+04 | −3.28E+03 | 4.44E+02 |
| R4 | −2.5535E+00 | 1.7933E+01 | −5.1882E+00 | 8.70E−01 | −6.44E−02 |
| R5 | −2.4036E+01 | −5.1287E−02 | 5.1285E−03 | −2.52E−04 | 2.54E−06 |
| R6 | −8.2016E+00 | −3.8268E−03 | 4.5751E−04 | −3.23E−05 | 1.01E−06 |

Among them, k is a conic coefficient A4, A6, A8, A10, A12, A14, A16, A18, A20, A22, A24, A26, A28 and A30 are aspheric coefficients.

$$y = ( {x}^{2} / R ) / [ 1 + {\{ 1 - ( k + 1 ) ( {x}^{2} {R}^{2} ) \}}^{1 / 2} ] + A 4 {x}^{4} + A 6 {x}^{6} + A 8 {x}^{8} + A 10 {x}^{10} + A 12 {x}^{12} + A 14 {x}^{14} + A 16 {x}^{16} + A 18 {x}^{18} + A 20 {x}^{20} + A 22 {x}^{22} + A 24 {x}^{24} + A 26 {x}^{26} + A 28 {x}^{28} + A 30 {x}^{30} \qquad ( 1 )$$

Among them, x is a vertical distance between a point on the aspheric curve and the optical axis, and y is a depth of the aspheric surface (a vertical distance between a point on the aspheric surface at a distance x from the optical axis and a tangent plane tangent to a vertex on the aspheric optical axis).

For convenience, the aspheric surface of each lens surface uses the aspheric surface shown in the above formula (1). However, the present disclosure is not limited to the aspheric polynomial form represented by the formula (1).

Table 3 and Table 4 show design data of inflection points and stationary points of each lens in the camera optical lens 10 of the present embodiment. Among them, P1R1 and P1R2 respectively represent the object-side surface and the image-side surface of the first lens L1, P2R1 and P2R2 respectively represent the object-side surface and the image-side surface of the second lens L2, and P3R1 and P3R2 respectively represent the object-side surface and the image-side surface of the third lens L3. The corresponding data in the column “inflection point position” is the vertical distance from the inflection point provided with the surface of each lens to the optical axis of the camera optical lens 10. The corresponding data in the column “stationary point position” is a vertical distance from the stationary point provided with the surface of each lens to the optical axis of the camera optical lens 10.

TABLE 3

| | Number of | Inflection point | Inflection point | Inflection point | Inflection point | Inflection point | Inflection point |
|---|---|---|---|---|---|---|---|
| | inflection points | position 1 | position 2 | position 3 | position 4 | position 5 | position 6 |
| P1R1 | 0 | / | / | / | / | / | / |
| P1R2 | 0 | / | / | / | / | / | / |
| P2R1 | 0 | / | / | / | / | / | / |
| P2R2 | 3 | 1.205 | 1.325 | 1.375 | / | / | / |
| P3R1 | 3 | 0.195 | 1.035 | 1.665 | / | / | / |
| P3R2 | 1 | 0.395 | / | / | / | / | / |

TABLE 4

| | Number of | | | | | |
|---|---|---|---|---|---|---|
| | stationary | Stationary point | Stationary point | Stationary point | Stationary point | Stationary point |
| | points | position 1 | position 2 | position 3 | position 4 | position 5 |
| P1R1 | 0 | / | / | / | / | / |
| P1R2 | 0 | / | / | / | / | / |
| P2R1 | 0 | / | / | / | / | / |
| P2R2 | 0 | / | / | / | / | / |
| P3R1 | 3 | 0.385 | 1.585 | 1.725 | / | / |
| P3R2 | 1 | 1.155 | / | / | / | / |

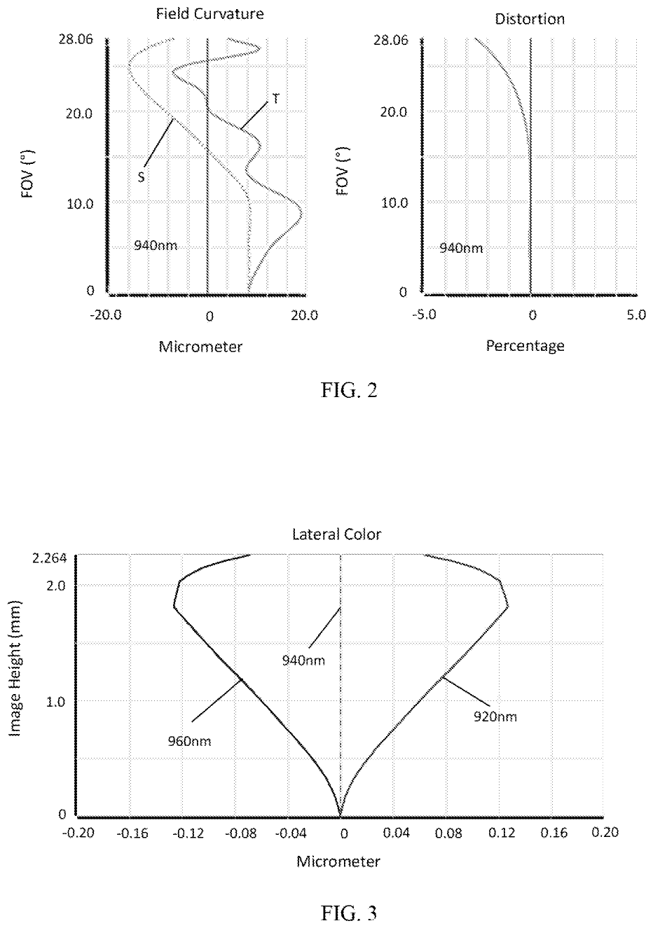

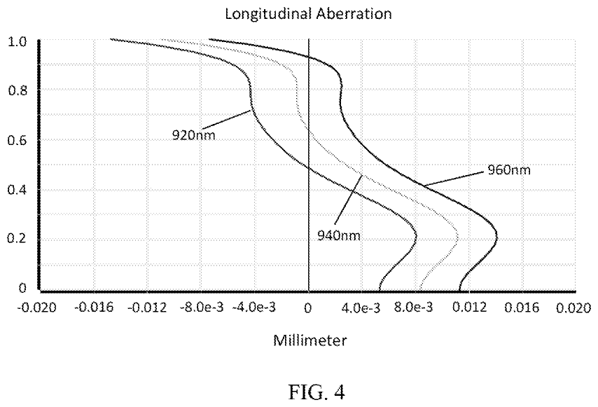

FIG. 2 shows field curvature and distortion of light with a wavelength of 940 nm after passing through the camera optical lens 10. The field curvature S in FIG. 2 is the field curvature in a sagittal direction, and T is the field curvature in a meridional direction. FIG. 3 and FIG. 4 respectively show lateral color and longitudinal aberration of light with wavelengths 960 nm, 940 nm and 920 nm after passing through the camera optical lens 10.

As shown in Table 25, Example 1 satisfies each relational expression.

In this embodiment, the entrance pupil diameter ENPD of the camera optical lens 10 is 2.123 mm, the full field image height IH is 2.264 mm, and the field of view FOV in the diagonal direction is 56.12°, so that the camera optical lens 10 meets the design requirements of low sensitivity and medium- to long-range distance imaging, its on-axis and off-axis chromatic aberrations are fully corrected, and has good optical characteristics.

### Example 2

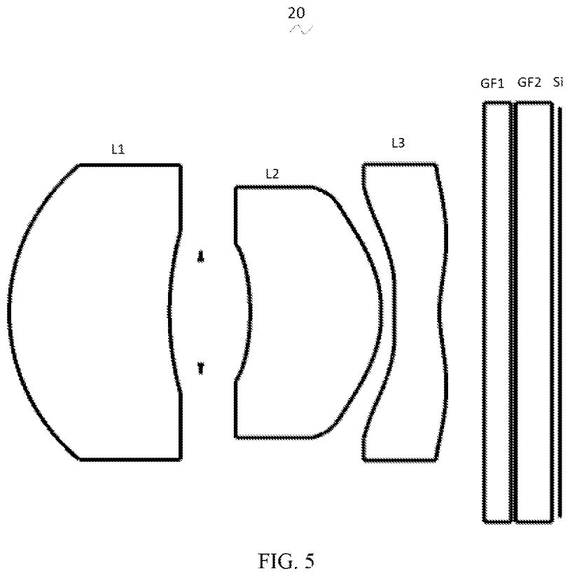

FIG. 5 is a structural schematic diagram of the camera optical lens 20 in Example 2, Example 2 is substantially the same as Example 1, and the symbols in the following list have the same meaning as those in Example 1, so the same parts are not described herein again.

Table 5 and Table 6 show design data of the camera optical lens 20 shown in FIG. 5.

TABLE 5

| | R | d | | nd | | νd | |
|---|---|---|---|---|---|---|---|
| S1 | ∞ | d0= | −2.122 | | | | |
| R1 | 2.327 | d1= | 1.774 | nd1 | 1.9108 | ν1 | 35.25 |
| R2 | 3.807 | d2= | 0.892 | | | | |
| R3 | −2.920 | d3= | 1.452 | nd2 | 1.6613 | ν2 | 20.37 |
| R4 | −1.939 | d4= | 0.146 | | | | |
| R5 | 5.962 | d5= | 0.495 | nd3 | 1.6613 | ν3 | 20.37 |
| R6 | 1.490 | d6= | 0.496 | | | | |
| R7 | ∞ | d7= | 0.300 | ndg1 | 1.5168 | νg1 | 64.17 |
| R8 | ∞ | d8= | 0.050 | | | | |
| R9 | ∞ | d9= | 0.400 | ndg2 | 1.5168 | νg2 | 64.17 |
| R10 | ∞ | d10= | 0.089 | | | | |

Table 6 shows aspheric surface data of each lens in the camera optical lens 20 according to Example 2 of the present disclosure.

TABLE 6

| | |
|---|---|
| Conic Coefficient | Aspherical Coefficient |

| | k | A4 | A6 | A8 | A10 | A12 |
|---|---|---|---|---|---|---|
| R3 | 1.1778E+01 | −4.4296E−02 | 9.2503E−01 | −1.2650E+01 | 1.1467E+02 | −6.7932E+02 |
| R4 | −3.4326E+00 | −6.5020E−01 | 2.8386E+00 | −8.6545E+00 | 1.7871E+01 | −2.2736E+01 |
| R5 | −1.1925E+02 | −1.0950E+00 | 3.1923E+00 | −7.0176E+00 | 1.1440E+01 | −1.3683E+01 |
| R6 | −1.2760E+01 | −3.5896E−01 | 6.8193E−01 | −1.0583E+00 | 1.2679E+00 | −1.1838E+00 |

| | Conic Coefficient | Aspherical Coefficient | | | | |
|---|---|---|---|---|---|---|
| | k | A14 | A16 | A18 | A20 | A22 |
| R3 | 1.1778E+01 | 2.7717E+03 | −8.0465E+03 | 1.6890E+04 | −2.5713E+04 | 2.8110E+04 |
| R4 | −3.4326E+00 | 1.0333E+01 | 2.0897E+01 | −5.0794E+01 | 5.6729E+01 | −3.9476E+01 |
| R5 | −1.1925E+02 | 1.2049E+01 | −7.8215E+00 | 3.7271E+00 | −1.2867E+00 | 3.1343E−01 |
| R6 | −1.2760E+01 | 8.7583E−01 | −5.1442E−01 | 2.3615E−01 | −8.2458E−02 | 2.1167E−02 |

| | |
|---|---|
| Conic Coefficient | Aspherical Coefficient |

| | k | A24 | A26 | A28 | A30 |
|---|---|---|---|---|---|
| R3 | 1.1778E+01 | −2.1480E+04 | 1.0883E+04 | −3.28E+03 | 4.40E+02 |
| R4 | −3.4326E+00 | 1.7933E+01 | −5.1882E+00 | 8.70E−01 | −6.44E−02 |
| R5 | −1.1925E+02 | −5.1287E−02 | 5.1284E−03 | −2.53E−04 | 2.43E−06 |
| R6 | −1.2760E+01 | −3.8268E−03 | 4.5751E−04 | −3.23E−05 | 1.01E−06 |

Table 7 and Table 8 show design data of inflection points and stationary points of each lens in the camera optical lens 20 of the present embodiment.

TABLE 7

| | Number of | Inflection point | Inflection point | Inflection point | Inflection point | Inflection point | Inflection point |
|---|---|---|---|---|---|---|---|
| | inflection points | position 1 | position 2 | position 3 | position 4 | position 5 | position 6 |
| P1R1 | 0 | / | / | / | / | / | / |
| P1R2 | 0 | / | / | / | / | / | / |
| P2R1 | 0 | / | / | / | / | / | / |
| P2R2 | 2 | 1.095 | 1.145 | / | / | / | / |
| P3R1 | 3 | 0.115 | 1.045 | 1.395 | / | / | / |
| P3R2 | 2 | 0.355 | 1.505 | / | / | / | / |

TABLE 8

| | Number of | Stationary point | Stationary point | Stationary point | Stationary point | Stationary point |
|---|---|---|---|---|---|---|
| | stationary points | position 1 | position 2 | position 3 | position 4 | position 5 |
| P1R1 | 0 | / | / | / | / | / |
| P1R2 | 0 | / | / | / | / | / |
| P2R1 | 0 | / | / | / | / | / |
| P2R2 | 0 | / | / | / | / | / |
| P3R1 | 1 | 0.205 | / | / | / | / |
| P3R2 | 1 | 0.875 | / | / | / | / |

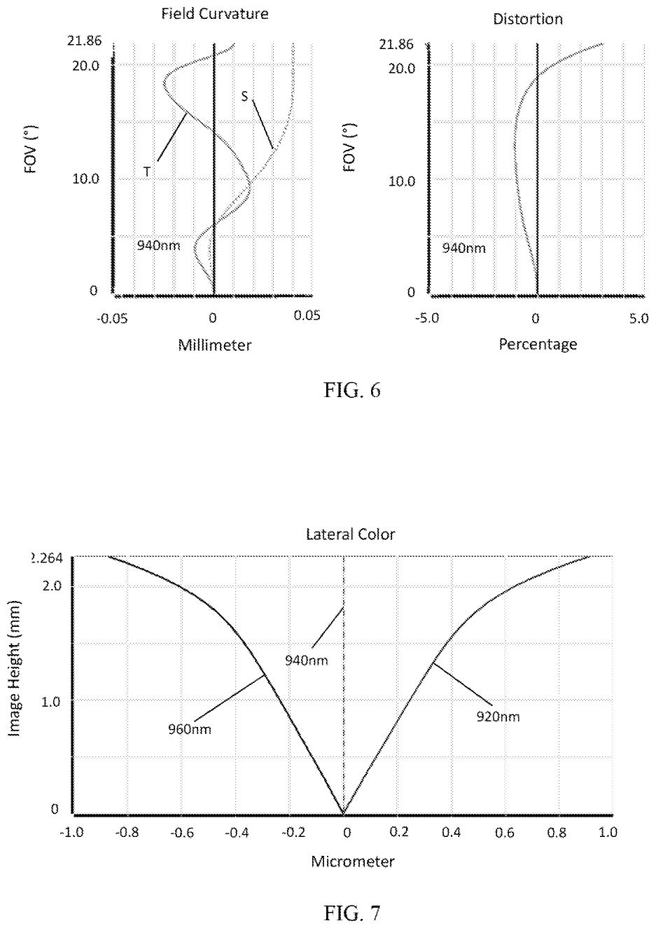

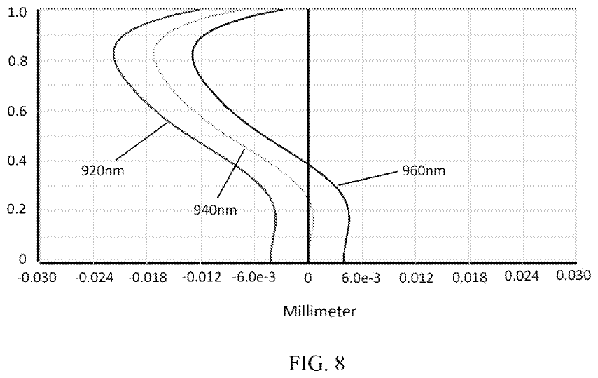

FIG. 6 shows field curvature and distortion of light with a wavelength of 940 nm after passing through the camera optical lens 20. The field curvature S in FIG. 6 is the field curvature in a sagittal direction, and T is the field curvature in a meridional direction. FIG. 7 and FIG. 8 respectively show lateral color and longitudinal aberration of light with wavelengths 960 nm, 940 nm and 920 nm after passing through the camera optical lens 20.

As shown in Table 25, Example 2 satisfies each relational expression.

In this embodiment, the entrance pupil diameter ENPD of the camera optical lens 20 is 2.123 mm, the full field image height IH is 2.264 mm, and the field-of-view FOV in the diagonal direction is 43.71°, so that the camera optical lens 20 meets the design requirements of low sensitivity and medium- to long-range distance imaging, its on-axis and off-axis chromatic aberrations are fully corrected, and has good optical characteristics.

### Example 3

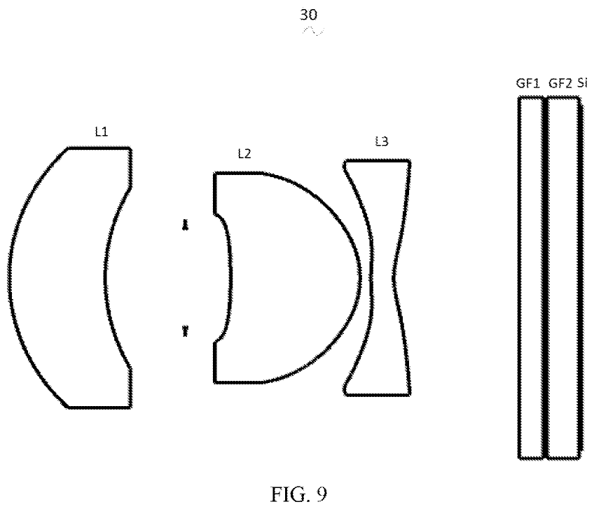

FIG. 9 is a structural schematic diagram of the camera optical lens 30 in Example 3, Example 3 is substantially the same as Example 1, and the symbols in the following list have the same meaning as those in Example 1, so the same parts are not described herein again.

Table 9 and Table 10 show design data of the camera optical lens 30 shown in FIG. 9.

TABLE 9

| | R | d | | nd | | νd | |
|---|---|---|---|---|---|---|---|
| S1 | ∞ | d0= | −2.218 | | | | |
| R1 | 2.485 | d1= | 1.211 | nd1 | 2.1042 | ν1 | 17.02 |
| R2 | 2.565 | d2= | 1.582 | | | | |
| R3 | −6.944 | d3= | 1.632 | nd2 | 1.6613 | ν2 | 20.37 |
| R4 | −1.394 | d4= | 0.139 | | | | |
| R5 | 2.074 | d5= | 0.288 | nd3 | 1.6613 | ν3 | 20.37 |
| R6 | 0.980 | d6= | 1.584 | | | | |
| R7 | ∞ | d7= | 0.300 | ndg1 | 1.5168 | νg1 | 64.17 |
| R8 | ∞ | d8= | 0.050 | | | | |
| R9 | ∞ | d9= | 0.400 | ndg2 | 1.5168 | νg2 | 64.17 |
| R10 | ∞ | d10= | 0.039 | | | | |

Table 10 shows aspherical surface data of each lens in the camera optical lens 30 as described in Example 3 of the present disclosure.

TABLE 10

| | |
|---|---|
| Conic Coefficient | Aspherical Coefficient |

| | k | A4 | A6 | A8 | A10 | A12 |
|---|---|---|---|---|---|---|
| R3 | 1.6969E+01 | −1.0695E−01 | 8.0536E−01 | −1.2718E+01 | 1.1469E+02 | −6.7940E+02 |
| R4 | −3.4764E+00 | −6.9852E−01 | 2.8313E+00 | −8.6643E+00 | 1.7873E+01 | −2.2736E+01 |
| R5 | −5.1589E+01 | −1.0830E+00 | 3.1857E+00 | −7.0200E+00 | 1.1440E+01 | −1.3683E+01 |
| R6 | −9.9781E+00 | −3.3407E−01 | 6.8534E−01 | −1.0591E+00 | 1.2676E+00 | −1.1838E+00 |

| | Conic Coefficient | Aspherical Coefficient | | | | |
|---|---|---|---|---|---|---|
| | k | A14 | A16 | A18 | A20 | A22 |
| R3 | 1.6969E+01 | 2.7718E+03 | −8.0466E+03 | 1.6890E+04 | −2.5713E+04 | 2.8108E+04 |
| R4 | −3.4764E+00 | 1.0332E+01 | 2.0896E+01 | −5.0794E+01 | 5.6729E+01 | −3.9476E+01 |
| R5 | −5.1589E+01 | 1.2049E+01 | −7.8215E+00 | 3.7269E+00 | −1.2867E+00 | 3.1343E−01 |
| R6 | −9.9781E+00 | 8.7584E−01 | −5.1442E−01 | 2.3615E−01 | −8.2458E−02 | 2.1167E−02 |

| | |
|---|---|
| Conic Coefficient | Aspherical Coefficient |

| | k | A24 | A26 | A28 | A30 |
|---|---|---|---|---|---|
| R3 | 1.6969E+01 | −2.1481E+04 | 1.0882E+04 | −3.28E+03 | 4.42E+02 |
| R4 | −3.4764E+00 | 1.7933E+01 | −5.1882E+00 | 8.70E−01 | −6.44E−02 |
| R5 | −5.1589E+01 | −5.1285E−02 | 5.1283E−03 | −2.52E−04 | 2.42E−06 |
| R6 | −9.9781E+00 | −3.8271E−03 | 4.5751E−04 | −3.22E−05 | 1.01E−06 |

Table 11 and Table 12 show design data of inflection points and stationary point of each lens in the camera optical lens 30 of the present embodiment.

TABLE 11

| | Number of | Inflection | Inflection | Inflection | Inflection | Inflection | Inflection |
|---|---|---|---|---|---|---|---|
| | inflection | point | point | point | point | point | point |
| | points | position 1 | position 2 | position 3 | position 4 | position 5 | position 6 |
| P1R1 | 0 | / | / | / | / | / | / |
| P1R2 | 0 | / | / | / | / | / | / |
| P2R1 | 0 | / | / | / | / | / | / |
| P2R2 | 0 | / | / | / | / | / | / |
| P3R1 | 2 | 0.175 | 1.405 | / | / | / | / |
| P3R2 | 2 | 0.385 | 1.575 | / | / | / | / |

TABLE 12

| | Number of | | | | | |
|---|---|---|---|---|---|---|
| | stationary | Stationary point | Stationary point | Stationary point | Stationary point | Stationary point |
| | points | position 1 | position 2 | position 3 | position 4 | position 5 |
| P1R1 | 0 | / | / | / | / | / |
| P1R2 | 0 | / | / | / | / | / |
| P2R1 | 0 | / | / | / | / | / |
| P2R2 | 0 | / | / | / | / | / |
| P3R1 | 2 | 0.335 | 1.525 | / | / | / |
| P3R2 | 0 | / | / | / | / | / |

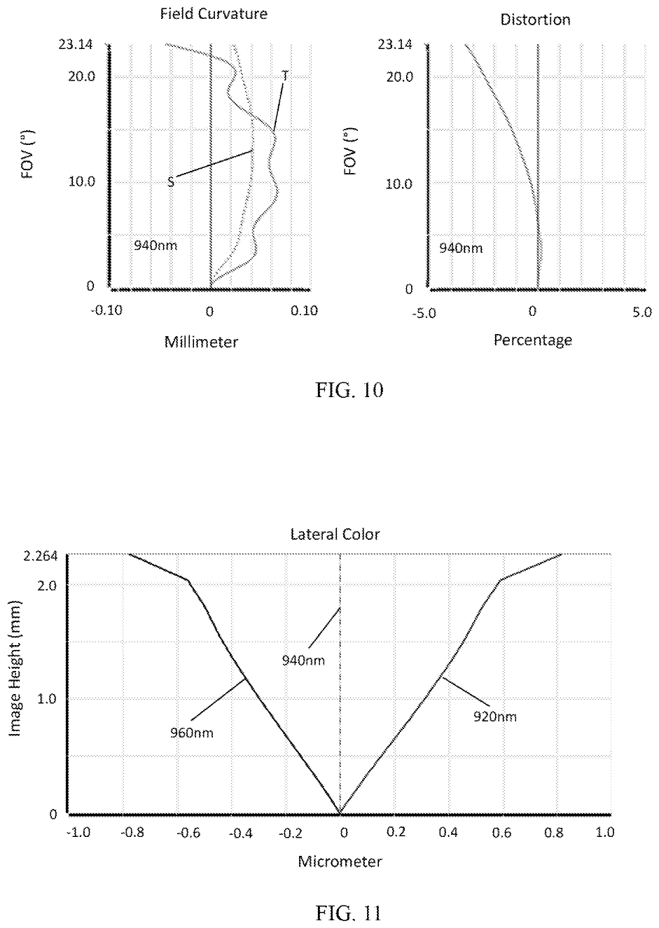

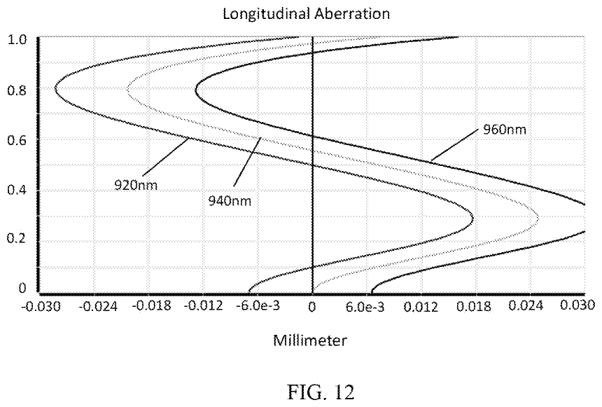

FIG. 10 shows field curvature and distortion of light with a wavelength of 940 nm after passing through the camera optical lens 30. The field curvature S in FIG. 10 is the field curvature in a sagittal direction, and T is the field curvature in a meridional direction. FIG. 11 and FIG. 12 respectively show lateral color and longitudinal aberration of light with wavelengths 960 nm, 940 nm and 920 nm after passing through the camera optical lens 30.

As shown in Table 25, Example 3 satisfies each relational expression.

In this embodiment, the entrance pupil diameter ENPD of the camera optical lens 30 is 2.123 mm, the full field image height IH is 2.264 mm, and the field of view FOV in the diagonal direction is 46.29°, so that the camera optical lens 30 meets the design requirements of low sensitivity and medium- to long-range distance imaging, its on-axis and off-axis chromatic aberrations are fully corrected, and has good optical characteristics.

### Example 4

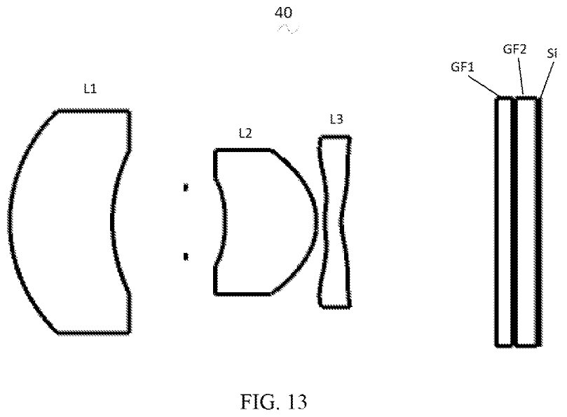

FIG. 13 is a structural schematic diagram of the camera optical lens 40 in Example 4, Example 4 is substantially the same as Example 1, and the symbols in the following list have the same meaning as Example 1, so the same parts are not described herein again.

Table 13 and Table 14 show design data of the camera optical lens 40 shown in FIG. 13.

TABLE 13

| | R | d | | nd | | vd | |
|---|---|---|---|---|---|---|---|
| S1 | ∞ | d0= | −3.227 | | | | |
| R1 | 3.203 | d1= | 1.883 | nd1 | 1.9108 | v1 | 35.25 |
| R2 | 3.401 | d2= | 2.071 | | | | |
| R3 | −2.997 | d3= | 1.678 | nd2 | 1.6613 | v2 | 20.37 |
| R4 | −1.709 | d4= | 0.153 | | | | |
| R5 | 1.621 | d5= | 0.303 | nd3 | 1.6613 | v3 | 20.37 |
| R6 | 1.154 | d6= | 2.844 | | | | |
| R7 | ∞ | d7= | 0.300 | ndg1 | 1.5168 | vg1 | 64.17 |
| R8 | ∞ | d8= | 0.050 | | | | |
| R9 | ∞ | d9= | 0.400 | ndg2 | 1.5168 | vg2 | 64.17 |
| R10 | ∞ | d10= | 0.055 | | | | |

Table 14 shows aspherical surface data of each lens in the camera optical lens 40 as described in Example 4 of the present disclosure.

TABLE 14

Conic

| | |
|---|---|
| Coefficient | Aspherical Coefficient |

| | k | A4 | A6 | A8 | A10 | A12 |
|---|---|---|---|---|---|---|
| R3 | 9.6945E+00 | −3.9761E−02 | 8.1534E−01 | −1.2672E+01 | 1.1478E+02 | −6.7920E+02 |
| R4 | −1.8676E+00 | −6.7921E−01 | 2.8561E+00 | −8.6660E+00 | 1.7869E+01 | −2.2737E+01 |
| R5 | −1.2867E+01 | −1.0841E+00 | 3.1901E+00 | −7.0181E+00 | 1.1440E+01 | −1.3683E+01 |
| R6 | −1.0246E+01 | −3.5666E−01 | 6.8676E−01 | −1.0569E+00 | 1.2679E+00 | −1.1839E+00 |

| | Conic | | | | | |
|---|---|---|---|---|---|---|
| | Coefficient | Aspherical Coefficient | | | | |
| | k | A14 | A16 | A18 | A20 | A22 |
| R3 | 9.6945E+00 | 2.7717E+03 | −8.0465E+03 | 1.6890E+04 | −2.5713E+04 | 2.8108E+04 |
| R4 | −1.8676E+00 | 1.0334E+01 | 2.0897E+01 | −5.0794E+01 | 5.6729E+01 | −3.9476E+01 |
| R5 | −1.2867E+01 | 1.2049E+01 | −7.8215E+00 | 3.7271E+00 | −1.2867E+00 | 3.1343E−01 |
| R6 | −1.0246E+01 | 8.7580E−01 | −5.1442E−01 | 2.3615E−01 | −8.2457E−02 | 2.1167E−02 |

Conic

| | |
|---|---|
| Coefficient | Aspherical Coefficient |

| | k | A24 | A26 | A28 | A30 |
|---|---|---|---|---|---|
| R3 | 9.6945E+00 | −2.1481E+04 | 1.0883E+04 | −3.28E+03 | 4.45E+02 |
| R4 | −1.8676E+00 | 1.7933E+01 | −5.1882E+00 | 8.70E−01 | −6.44E−02 |
| R5 | −1.2867E+01 | −5.1287E−02 | 5.1285E−03 | −2.52E−04 | 2.54E−06 |
| R6 | −1.0246E+01 | −3.8267E−03 | 4.5752E−04 | −3.23E−05 | 1.01E−06 |

Table 15 and Table 16 show design data of inflection points and stationary point of each lens in the camera optical lens 40 of the present embodiment.

TABLE 15

| | Number of | Inflection | Inflection | Inflection | Inflection | Inflection | Inflection |
|---|---|---|---|---|---|---|---|
| | inflection | point | point | point | point | point | point |
| | points | position 1 | position 2 | position 3 | position 4 | position 5 | position 6 |
| P1R1 | 0 | / | / | / | / | / | / |
| P1R2 | 0 | / | / | / | / | / | / |
| P2R1 | 0 | / | / | / | / | / | / |
| P2R2 | 1 | 1.385 | / | / | / | / | / |
| P3R1 | 2 | 0.225 | 1.025 | / | / | / | / |
| P3R2 | 2 | 0.375 | 1.185 | / | / | / | / |

TABLE 16

| | Number of | | | | | |
|---|---|---|---|---|---|---|
| | stationary | Stationary point | Stationary point | Stationary point | Stationary point | Stationary point |
| | points | position 1 | position 2 | position 3 | position 4 | position 5 |
| P1R1 | 0 | / | / | / | / | / |
| P1R2 | 0 | / | / | / | / | / |
| P2R1 | 0 | / | / | / | / | / |
| P2R2 | 0 | / | / | / | / | / |
| P3R1 | 2 | 0.475 | 1.465 | / | / | / |
| P3R2 | 0 | / | / | / | / | / |

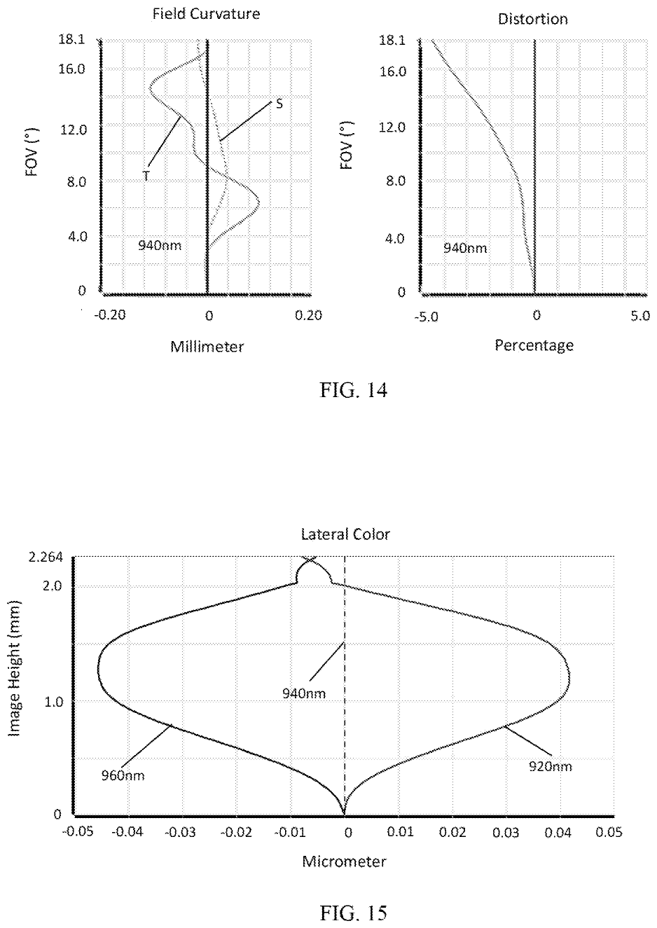

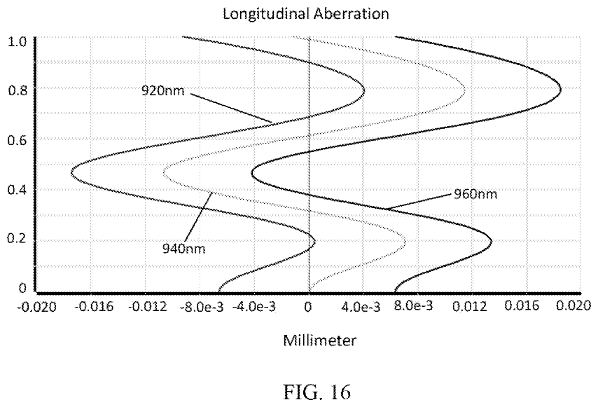

FIG. 14 shows field curvature and distortion of light with a wavelength of 940 nm after passing through the camera optical lens 40. The field curvature S in FIG. 14 is the field curvature in a sagittal direction, and T is the field curvature in a meridional direction. FIG. 15 and FIG. 16 respectively show lateral color and longitudinal aberration of light with wavelengths 960 nm, 940 nm and 920 nm after passing through the camera optical lens 40.

As shown in Table 25, Example 4 satisfies each relational expression.

In this embodiment, the entrance pupil diameter ENPD of the camera optical lens 40 is 2.123 mm, the full field image height IH is 2.264 mm, and the field of view FOV in the diagonal direction is 36.220, so that the camera optical lens 40 meets the design requirements of low sensitivity and medium- to long-range distance imaging, its on-axis and off-axis chromatic aberrations are fully corrected, and has good optical characteristics.

### Example 5

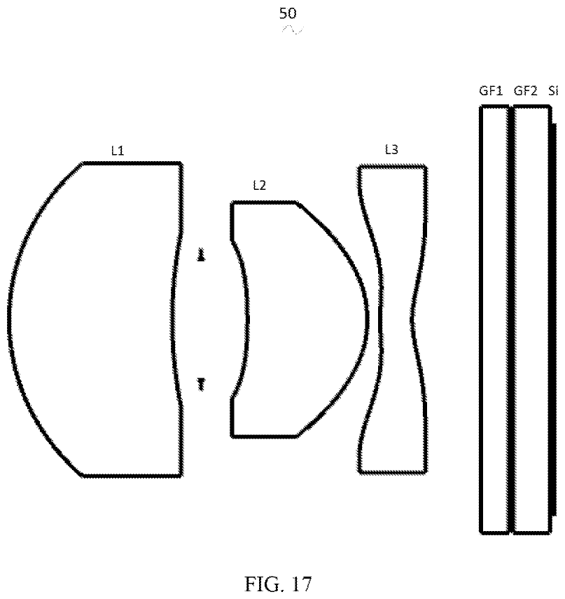

FIG. 17 is a structural schematic diagram of the camera optical lens 50 in Example 5, Example 5 is substantially the same as Example 1, and the symbols in the following list have the same meaning as Example 1, so the same parts are not described herein again.

Table 17 and Table 18 show design data of the camera optical lens 50 shown in FIG. 17.

TABLE 17

| | R | d | | nd | | vd | |
|---|---|---|---|---|---|---|---|
| S1 | ∞ | d0= | −2.091 | | | | |
| R1 | 2.442 | d1= | 1.776 | nd1 | 1.7130 | v1 | 53.87 |
| R2 | 5.319 | d2= | 0.820 | | | | |
| R3 | −4.639 | d3= | 1.303 | nd2 | 1.6613 | v2 | 20.37 |
| R4 | −1.508 | d4= | 0.140 | | | | |
| R5 | 2.138 | d5= | 0.348 | nd3 | 1.6613 | v3 | 20.37 |
| R6 | 1.072 | d6= | 0.752 | | | | |
| R7 | ∞ | d7= | 0.300 | ndg1 | 1.5168 | vg1 | 64.17 |
| R8 | ∞ | d8= | 0.050 | | | | |
| R9 | ∞ | d9= | 0.400 | ndg2 | 1.5168 | vg2 | 64.17 |
| R10 | ∞ | d10= | 0.045 | | | | |

Table 18 shows aspheric surface data of each lens in the camera optical lens 50 according to Example 5 of the present disclosure.

TABLE 18

Conic

| | |
|---|---|
| Coefficient | Aspherical Coefficient |

| | k | A4 | A6 | A8 | A10 | A12 |
|---|---|---|---|---|---|---|
| R3 | 1.4900E+01 | −1.0045E−01 | 8.0964E−01 | −1.2699E+01 | 1.1483E+02 | −6.7922E+02 |
| R4 | −2.6545E+00 | −6.8164E−01 | 2.8433E+00 | −8.6631E+00 | 1.7870E+01 | −2.2736E+01 |
| R5 | −3.0193E+01 | −1.0901E+00 | 3.1909E+00 | −7.0179E+00 | 1.1440E+01 | −1.3683E+01 |
| R6 | −9.1851E+00 | −3.4749E−01 | 6.8340E−01 | −1.0587E+00 | 1.2679E+00 | −1.1838E+00 |

| | Conic | | | | | |
|---|---|---|---|---|---|---|
| | Coefficient | Aspherical Coefficient | | | | |
| | k | A14 | A16 | A18 | A20 | A22 |
| R3 | 1.4900E+01 | 2.7717E+03 | −8.0466E+03 | 1.6890E+04 | −2.5713E+04 | 2.8108E+04 |
| R4 | −2.6545E+00 | 1.0333E+01 | 2.0897E+01 | −5.0794E+01 | 5.6729E+01 | −3.9476E+01 |
| R5 | −3.0193E+01 | 1.2049E+01 | −7.8215E+00 | 3.7271E+00 | −1.2867E+00 | 3.1343E−01 |
| R6 | −9.1851E+00 | 8.7583E−01 | −5.1442E−01 | 2.3615E−01 | −8.2458E−02 | 2.1167E−02 |

Conic

| | |
|---|---|
| Coefficient | Aspherical Coefficient |

| | k | A24 | A26 | A28 | A30 |
|---|---|---|---|---|---|
| R3 | 1.4900E+01 | −2.1481E+04 | 1.0883E+04 | −3.28E+03 | 4.44E+02 |
| R4 | −2.6545E+00 | 1.7933E+01 | −5.1882E+00 | 8.70E−01 | −6.44E−02 |
| R5 | −3.0193E+01 | −5.1287E−02 | 5.1285E−03 | −2.52E−04 | 2.54E−06 |
| R6 | −9.1851E+00 | −3.8268E−03 | 4.5752E−04 | −3.23E−05 | 1.01E−06 |

Table 19 and Table 20 show design data of inflection points and stationary points of each lens in the camera optical lens 50 of the present embodiment.

TABLE 19

| | Number of | Inflection | Inflection | Inflection | Inflection | Inflection | Inflection |
|---|---|---|---|---|---|---|---|
| | inflection | point | point | point | point | point | point |
| | points | position 1 | position 2 | position 3 | position 4 | position 5 | position 6 |
| PIR1 | 0 | / | / | / | / | / | / |
| PIR2 | 0 | / | / | / | / | / | / |
| P2R1 | 0 | / | / | / | / | / | / |
| P2R2 | 0 | / | / | / | / | / | / |
| P3R1 | 2 | 0.185 | 1.055 | / | / | / | / |
| P3R2 | 2 | 0.395 | 1.445 | / | / | / | / |

TABLE 20

| | Number of | | | | | |
|---|---|---|---|---|---|---|
| | stationary | Stationary point | Stationary point | Stationary point | Stationary point | Stationary point |
| | points | position 1 | position 2 | position 3 | position 4 | position 5 |
| P1R1 | 0 | / | / | / | / | / |
| P1R2 | 0 | / | / | / | / | / |
| P2R1 | 0 | / | / | / | / | / |
| P2R2 | 0 | / | / | / | / | / |
| P3R1 | 2 | 0.365 | 1.615 | / | / | / |
| P3R2 | 2 | 1.315 | 1.585 | / | / | / |

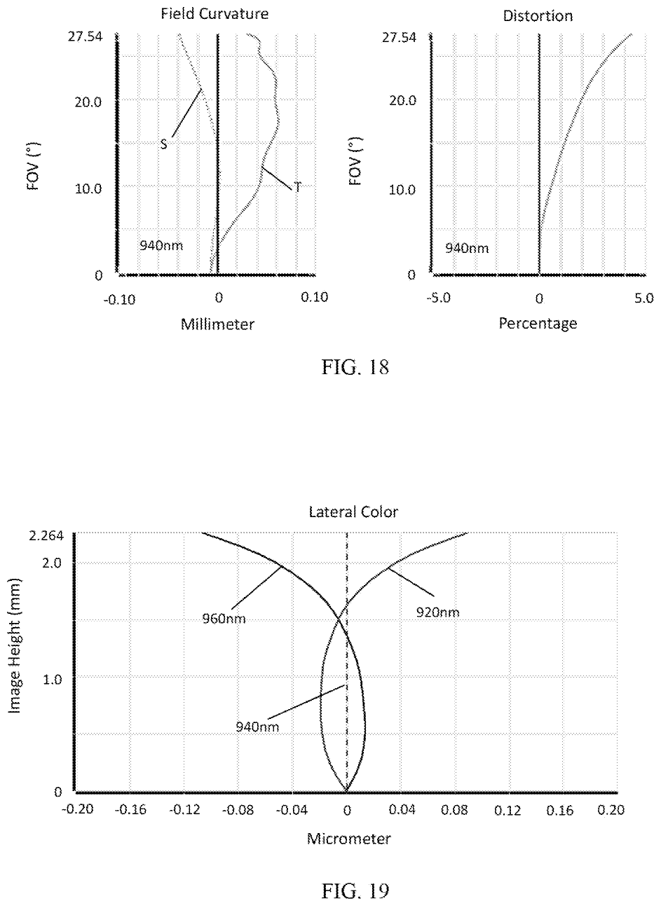

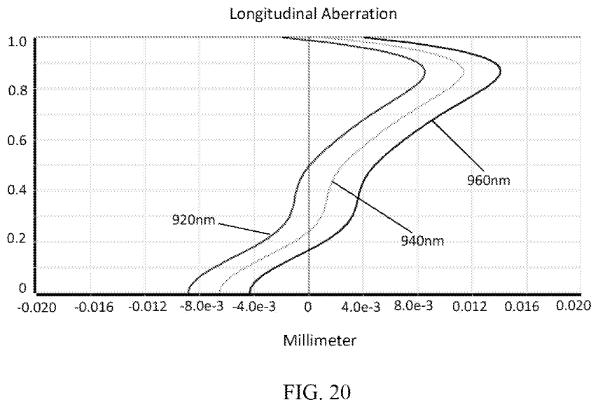

FIG. 18 shows field curvature and distortion of light with a wavelength of 940 nm after passing through the camera optical lens 50. The field curvature S in FIG. 18 is the field curvature in a sagittal direction, and T is the field curvature in a meridional direction. FIG. 19 and FIG. 20 respectively show lateral color and longitudinal aberration of light with wavelengths 960 nm, 940 nm and 920 nm after passing through the camera optical lens 50.

As shown in Table 25, Example 5 satisfies each relational expression.

In this embodiment, the entrance pupil diameter ENPD of the camera optical lens 50 is 2.123 mm, the full field image height IH is 2.264 mm, and the field of view FOV in the diagonal direction is 55.08°, so that the camera optical lens 30 meets the design requirements of low sensitivity and medium- to long-range distance imaging, its on-axis and off-axis chromatic aberrations are fully corrected, and has good optical characteristics.

### Comparative Example

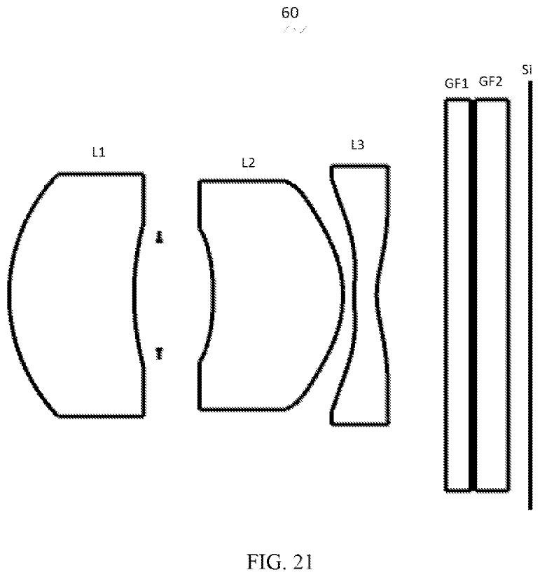

FIG. 21 is a structural schematic diagram of the camera optical lens 50 in the Comparative Example, and the symbols in the following list have the same meaning as those in Example 1, so the same parts are not described herein again.

Table 21 and Table 22 show design data of the camera optical lens 60 shown in FIG. 21.

TABLE 21

| | R | d | | nd | | vd | |
|---|---|---|---|---|---|---|---|
| S1 | ∞ | d0= | −1.806 | | | | |
| R1 | 2.280 | d1= | 1.502 | nd1 | 1.9108 | v1 | 35.25 |
| R2 | 3.674 | d2− | 0.954 | | | | |
| R3 | −3.040 | d3= | 1.558 | nd2 | 1.6613 | v2 | 20.37 |
| R4 | −1.832 | d4= | 0.136 | | | | |
| R5 | 2.595 | d5= | 0.270 | nd3 | 1.6613 | v3 | 20.37 |
| R6 | 1.131 | d6= | 0.834 | | | | |
| R7 | ∞ | d7= | 0.300 | ndg1 | 1.5168 | vg1 | 64.17 |
| R8 | ∞ | d8= | 0.050 | | | | |
| R9 | ∞ | d9= | 0.400 | ndg2 | 1.5168 | vg2 | 64.17 |
| R10 | ∞ | d10= | 0.262 | | | | |

Table 22 shows aspherical surface data of each lens in the camera optical lens 60 as described in Comparative Example of the present disclosure.

TABLE 22

Conic

| | |
|---|---|
| Coefficient | Aspherical Coefficient |

| | k | A4 | A6 | A8 | A10 | A12 |
|---|---|---|---|---|---|---|
| R3 | 1.1988E+01 | −1.9621E−02 | 8.5023E−01 | −1.2763E+01 | 1.1482E+02 | −6.7899E+02 |
| R4 | −4.6347E+00 | −6.5376E−01 | 2.8509E+00 | −8.6617E+00 | 1.7870E+01 | −2.2736E+01 |
| R5 | −2.8999E+01 | −1.0937E+00 | 3.1900E+00 | −7.0181E+00 | 1.1440E+01 | −1.3683E+01 |
| R6 | −9.3879E+00 | −3.4779E−01 | 6.8315E−01 | −1.0588E+00 | 1.2679E+00 | −1.1838E+00 |

| | Conic | | | | | |
|---|---|---|---|---|---|---|
| | Coefficient | Aspherical Coefficient | | | | |
| | k | A14 | A16 | A18 | A20 | A22 |
| R3 | 1.1988E+01 | 2.7721E+03 | −8.0466E+03 | 1.6889E+04 | −2.5714E+04 | 2.8108E+04 |
| R4 | −4.6347E+00 | 1.0333E+01 | 2.0897E+01 | −5.0794E+01 | 5.6729E+01 | −3.9476E+01 |
| R5 | −2.8999E+01 | 1.2049E+01 | −7.8215E+00 | 3.7271E+00 | −1.2867E+00 | 3.1343E−01 |
| R6 | −9.3879E+00 | 8.7583E−01 | −5.1442E−01 | 2.3615E−01 | −8.2458E−02 | 2.1167E−02 |

Conic

| | |
|---|---|
| Coefficient | Aspherical Coefficient |

| | k | A24 | A26 | A28 | A30 |
|---|---|---|---|---|---|
| R3 | 1.1988E+01 | −2.1481E+04 | 1.0883E+04 | −3.28E+03 | 4.47E+02 |
| R4 | −4.6347E+00 | 1.7933E+01 | −5.1882E+00 | 8.70E−01 | −6.44E−02 |
| R5 | −2.8999E+01 | −5.1287E−02 | 5.1284E−03 | −2.52E−04 | 2.48E−06 |
| R6 | −9.3879E+00 | −3.8268E−03 | 4.5753E−04 | −3.23E−05 | 1.02E−06 |

Table 23 and Table 24 show design data of inflection points and stationary points of each lens in the camera optical lens 60 of the present Comparative Example.

TABLE 23

| | Number of | Inflection | Inflection | Inflection | Inflection | Inflection | Inflection |
|---|---|---|---|---|---|---|---|
| | inflection | point | point | point | point | point | point |
| | points | position 1 | position 2 | position 3 | position 4 | position 5 | position 6 |
| PIR1 | 0 | / | / | / | / | / | / |
| PIR2 | 0 | / | / | / | / | / | / |
| P2R1 | 0 | / | / | / | / | / | / |
| P2R2 | 0 | / | / | / | / | / | / |
| P3R1 | 3 | 0.175 | 1.115 | 1.355 | / | / | / |
| P3R2 | 2 | 0.395 | 1.405 | / | / | / | / |

TABLE 24

| | Number of | | | | | |
|---|---|---|---|---|---|---|
| | stationary | Stationary point | Stationary point | Stationary point | Stationary point | Stationary point |
| | points | position 1 | position 2 | position 3 | position 4 | position 5 |
| PIR1 | 0 | / | / | / | / | / |
| PIR2 | 0 | / | / | / | / | / |
| P2R1 | 0 | / | / | / | / | / |
| P2R2 | 0 | / | / | / | / | / |
| P3R1 | 1 | 0.335 | / | / | / | / |
| P3R2 | 2 | 1.205 | 1.505 | / | / | / |

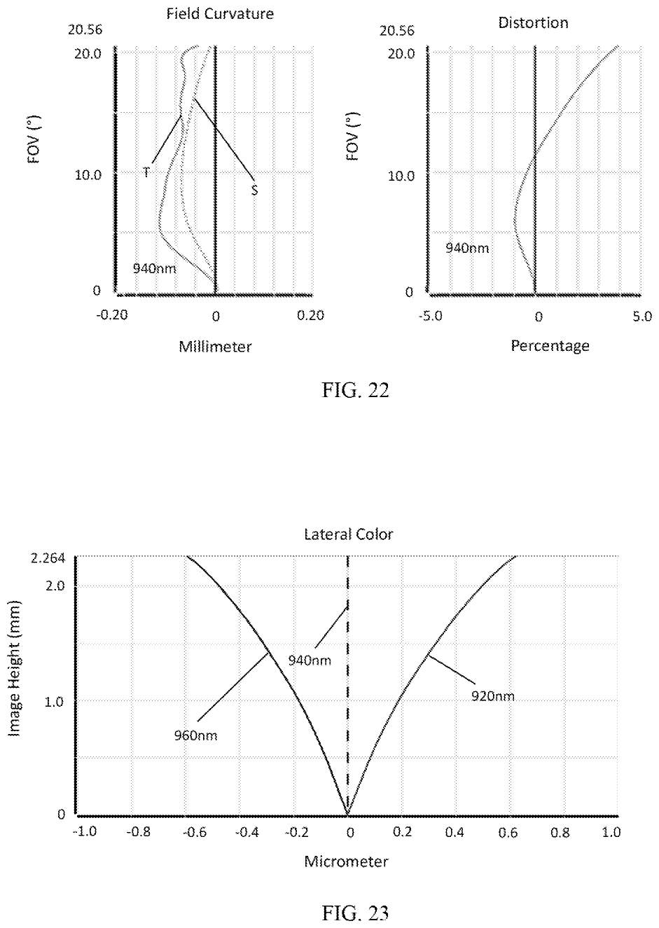

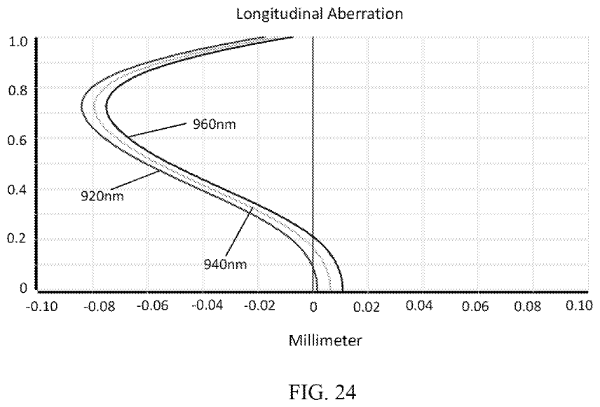

FIG. 22 shows field curvature and distortion of light with a wavelength of 940 nm after passing through the camera optical lens 60. The field curvature S in FIG. 22 is the field curvature in a sagittal direction, and T is the field curvature in a meridional direction. FIG. 23 and FIG. 24 respectively show lateral color and longitudinal aberration of light with wavelengths 960 nm, 940 nm and 920 nm after passing through the camera optical lens 60.

In this Comparative Example, the entrance pupil diameter ENPD of the camera optical lens 60 is 2.123 mm, the full field image height IH is 2.264 mm, and the field of view FOV in the diagonal direction is 41.11°.

Table 25 shows the values corresponding to the various values and parameters specified in the relational expressions in Examples 1-5 and the Comparative Example. Obviously, the camera optical lens 60 in the Comparative Example does not satisfy the above relational expression: 0.80≤f1/f≤1.60. The camera optical lens 60 cannot effectively consider both lower sensitivity and medium- to long-range distance imaging, and the optical performance is not good enough.

TABLE 25

| Parameters and | | | | | | |
|---|---|---|---|---|---|---|
| relational | | | | | | Comparative |
| expressions | Example 1 | Example 2 | Example 3 | Example 4 | Example 5 | example |
| f1/f | 1.22 | 0.80 | 1.60 | 1.58 | 1.25 | 0.78 |
| d2/TTL | 0.17 | 0.15 | 0.22 | 0.21 | 0.14 | 0.15 |
| (FOV* f)/IH | 107.36 | 103.96 | 110.77 | 114.65 | 100.11 | 104.18 |
| R5/R6 | 2.01 | 4.00 | 2.12 | 1.41 | 2.00 | 2.29 |
| n1 | 1.91 | 1.91 | 2.10 | 1.91 | 1.71 | 1.91 |
| f | 4.331 | 5.384 | 5.420 | 7.162 | 4.115 | 5.734 |
| f1 | 5.260 | 4.313 | 8.648 | 11.328 | 5.144 | 4.496 |
| f2 | 3.220 | 5.772 | 2.465 | 4.156 | 3.027 | 4.837 |
| f3 | −3.786 | −3.269 | −3.257 | −8.436 | −3.876 | −3.451 |
| f12 | 3.373 | 4.171 | 3.411 | 5.413 | 3.248 | 4.036 |
| FNO | 2.04 | 2.54 | 2.55 | 3.37 | 1.94 | 2.70 |

Those skilled in the art can understand that the above embodiments are specific embodiments for implementing the present disclosure, and in practical applications, various changes may be made in form and detail without departing from the spirit and scope of the present disclosure.

What is claimed is:

1. A camera optical lens, comprising from an object side to an image side: a first lens, a second lens and a third lens;
wherein a focal length of the camera optical lens is f, a focal length of the first lens is f1, an on-axis distance from an image-side surface of the first lens to an object-side surface of the second lens is d2, a total optical length from an object side surface of the first lens to an image plane of the camera optical lens along an optic axis of the camera optical lens is TTL, a field of view of the camera optical lens is FOV, a full field image height of the camera optical lens is IH, a curvature radius of an object-side surface of the third lens is R5, a curvature radius of an image-side surface of the third lens is R6, a refractive index of the first lens is n1, and following relational expressions are satisfied:
$$0.8 \leq f 1 / f \leq 1.6 ;$$
$$0.14 \leq d 2 / TTL \leq 0.22 ;$$
$$100. \leq ( FOV * f ) / IH \leq 115. ;$$
$$1.4 \leq R 5 / R 6 \leq 4. ; and$$
$$1.7 \leq n 1 \leq 2.1 .$$

2. The camera optical lens as described in claim 1, wherein a focal length of the second lens is f2, an on-axis thickness of the second lens is d3, and a following relational expression is satisfied:
$$1.5 \leq f 2 / d 3 \leq 4. .$$

3. The camera optical lens as described in claim 1, wherein a curvature radius of an object-side surface of the second lens is R3, a curvature radius of an image-side surface of the second lens is R4, and a following relational expression is satisfied:
$$1.5 \leq R 3 / R 4 \leq 5. .$$

4. The camera optical lens as described in claim 1, wherein a focal length of the third lens is f3, and a following relational expression is satisfied:
$$- 1.2 \leq f 3 / f \leq - 0.6 .$$

5. The camera optical lens as described in claim 1, wherein the first lens has a positive refractive power, an object-side surface of the first lens is convex in a paraxial region, and an image-side surface of the first lens is concave in the paraxial region;
a curvature radius of an object-side surface of the first lens is R1, a curvature radius of an image-side surface of the first lens is R2, and an on-axis thickness of the first lens is d1, and following relational expressions are satisfied:
$$- 126.25 \leq ( R 1 + R 2 ) / ( R 1 - R 2 ) \leq - 1.8 ; and$$
$$0.08 \leq d 1 / TTL \leq 0.45 .$$

6. The camera optical lens as described in claim 1, wherein the second lens has a positive refractive power, an object-side surface of the second lens is concave in a paraxial region, and an image-side surface of the second lens is convex in the paraxial region;
a focal length of the second lens is f2, an on-axis thickness of the second lens is d3, a curvature radius of an object-side surface of the second lens is R3, a curvature radius of an image-side surface of the second lens is R4, and following relational expressions are satisfied:
$$0.23 \leq f 2 / f \leq 1.61 ;$$
$$0.75 \leq ( R 3 + R 4 ) / ( R 3 - R 4 ) \leq 7.43 ; and$$
$$0.09 \leq d 3 / TTL \leq 0.36 .$$

7. The camera optical lens as described in claim 1, wherein the third lens has a negative refractive power, an object-side surface of the third lens is convex in a paraxial region, and an image-side surface of the third lens is concave in the paraxial region;
an on-axis thickness of the third lens is d5, and following relational expressions are satisfied:
$$0.83 \leq ( R 5 + R 6 ) / ( R 5 - R 6 ) \leq 8.91 ; and$$
$$0.02 \leq d 5 / TTL \leq 0.12 .$$

8. The camera optical lens as described in claim 1, a combined focal length of the first lens and the second lens is f12, and a following relational expression is satisfied:
$$0.31 \leq f 12 / f \leq 1.18 .$$

9. The camera optical lens as described in claim 1, wherein an F-number of the camera optical lens is FNO, and a following relational expression is satisfied:
$$FNO \leq 3.47 .$$

10. The camera optical lens as described in claim 1, wherein the first lens is made of glass, and the second lens and the third lens are made of plastic.
